(19) United States
(12) Patent Application Publication
(10) Pub. No.: US 2008/0307482 A1
(43) Pub. Date: Dec. 11, 2008

(54) SYSTEM AND METHOD OF ACCESSING MULTICAST DIGITAL VIDEO BROADCASTS

(75) Inventors: Shree Dandekar, Round Rock, TX (US); Subramanian Jayaram, Austin, TX (US); James Clardy, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/759,016

(22) Filed: Jun. 6, 2007

(51) Int. Cl. H04N 7/173

(52) U.S. Cl. 725/131

(57) ABSTRACT

A system and method of accessing and recording digital video broadcasts is disclosed. In one form, a method can include receiving a multicast digital video broadcast (DVB) signal and demodulating the multicast DVB signal to access a plurality of DVB data streams. The method can include initiating a processing the plurality of DVB data streams using a first DVB decapsulation module to detect a first DVB data stream and a second DVB data stream. The method can include detecting a first index frame within the first DVB data stream and detecting a second index frame within the second DVB data stream. The method can include storing a second index frame pointer identifying the second index frame and initiating an outputting of the first DVB data stream to a first display window.

### CROSS-REFERENCE TO RELATED APPLICATIONS

This application is related to U.S. patent application Ser. Nos. ______ entitled “System and Method of Accessing Digital Video Broadcasts within an Information Handling System” by Sicher et al. filed on Jun. 6, 2007 (Attorney Docket No. DC-13119), and ______ entitled “System and Method of Enabling Digital Video Broadcast Access within an Information Handling System” by Dandekar et al. filed on Jun. 6, 2007 (Attorney Docket No. DC-13322) both of which are assigned to the current assignee hereof and are hereby incorporated by reference in their entireties.

### FIELD OF THE DISCLOSURE

This disclosure relates generally to information handling systems, and more particularly to a system and method of accessing and recording digital video broadcasts.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can be configured to use a variety of hardware and software components that can be configured to process, store, and communicate information and can include one or more computer systems, data storage systems, and networking systems.

Some network broadcast systems can configure digital video broadcast information to be communicated to target devices optimized to output specific digital video broadcast signals received from a specific carrier. For example, some portable electronic devices, such as wireless personal digital assistants (PDAs), mobile phones, cellular devices, or various other handheld devices, have limited resources to process and output received digital video broadcast signals. Handset manufacturers can employ carrier specific chipsets and applications within handsets to process and display digital video broadcasts on mini-displays or screens of portable electronic devices. However, limiting reception and display resolution of portable electronic devices and digital video broadcasts may not be desirable to various users.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 illustrates a functional block diagram digital video broadcast processing system according to one aspect of the disclosure;

FIG. 3 illustrates a flow diagram of a method of accessing multiple digital video broadcasts streams from a multicast digital video broadcast signal according to one aspect of the disclosure;

FIG. 4 illustrates a functional block diagram of digital video broadcast network and digital video broadcast processing system according to one aspect of the disclosure; and

FIG. 5 illustrates a graphical user interface operable to display simultaneous digital video broadcast channels according to one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a wireless communication device, a diskless computer system, a thin client, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

According to one aspect of the disclosure, an information handling system operable to process digital video broadcast (DVB) signals is disclosed. The information handling system can include a DVB receiver operable to receive a multicast DVB signal, and a processor operable to initiate processing of the multicast DVB signal. The information handling system can further include a demodulator operably coupled to the processor. The demodulator can be operable to detect a first DVB data stream within the multicast DVB signal. The information handling system can also include a decapsulation module accessible by the DVB processing module and operable to detect a first index frame within the first DVB data stream, and a storage device operable to store a first index frame pointer reference operable to be updated in response to detecting the first index frame to identify the first index frame. The information handling system can further include the storage device further operable to store the first DVB data stream relative to the first index frame, and a display operable to display a first DVB channel data of the first DVB data stream. The display can be further operable to output a subsequent related first DVB channel data within a first window.

According to another aspect of the disclosure, a method of processing a digital video broadcast signal is disclosed. The method can include receiving a multicast DVB signal and demodulating the multicast DVB signal to access a plurality of DVB data streams. The method can also include initiating a processing the plurality of DVB data streams using a first DVB decapsulation module to detect a first DVB data stream and a second DVB data stream. The method can further include detecting a first index frame within the first DVB data stream and detecting a second index frame within the second DVB data stream. The method can also include storing a second index frame pointer identifying the second index frame and initiating an outputting of the first DVB data stream to a first display window. The method can further include storing the second DVB data stream relative to the second index frame within a storage device.

According to a further aspect of the disclosure, an information handling system including a wireless DVB receiver operable to receive a multicast DVB signal including a plurality of DVB data streams is disclosed. The information handling system can include a demultiplexer operable to separate the plurality of DVB data streams, and a storage device operable to store time sliced video frames of the plurality of DVB data streams. The information handling system can further include a DVB processing module operable to initiate a decapsulation and detection of a plurality of index frames within each of the plurality of DVB data streams. The information handling system can also include a plurality of index frame pointers updated in response to detecting the plurality of index frames, and a graphical user interface operable to display a first display window operable to display a first enhanced DVB channel data. In one form, the first display window can include a first window size. The graphical user interface can also include a second display window operable to display a second DVB channel data. The second display window can include a second window size smaller than the first window size.

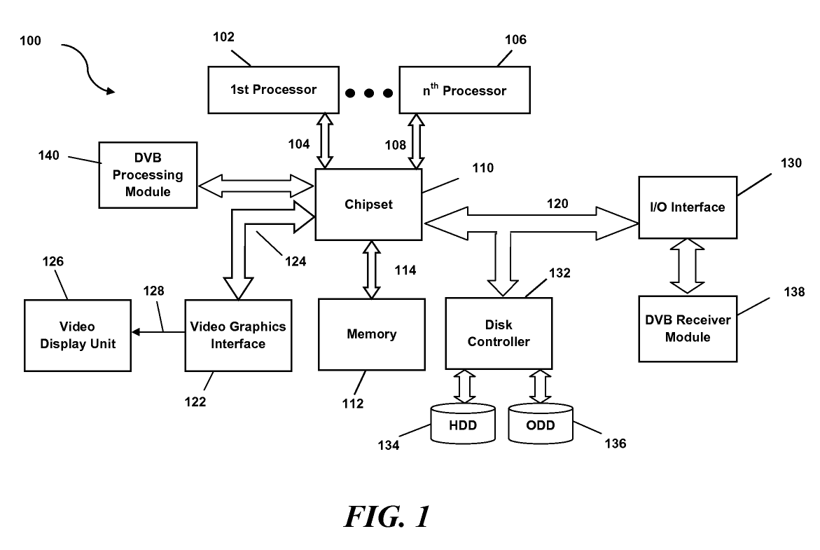

FIG. 1 illustrates a block diagram of an exemplary embodiment of an information handling system, generally designated at 100. In one form, the information handling system 100 can be a computer system such as a server. As shown in FIG. 1, the information handling system 100 can include a first physical processor 102 coupled to a first host bus 104 and can further include additional processors generally designated as n^{th} physical processor 106 coupled to a second host bus 108. The first physical processor 102 can be coupled to a chipset 110 via the first host bus 104. Further, the n^{th} physical processor 106 can be coupled to the chipset 110 via the second host bus 108. The chipset 110 can support multiple processors and can allow for simultaneous processing of multiple processors and support the exchange of information within information handling system 100 during multiple processing operations.

According to one aspect, the chipset 110 can be referred to as a memory hub or a memory controller. For example, the chipset 110 can include a dedicated bus to transfer data between first physical processor 102 and the n^{th} physical processor 106. For example, the chipset 110 including a chipset that can include a memory controller hub and an input/output (I/O) controller hub. As a memory controller hub, the chipset 110 can function to access the first physical processor 102 using first bus 104 and the n^{th} physical processor 106 using the second host bus 108. The chipset 110 can also be used as a memory interface for accessing memory 112 using a memory bus 114. In a particular embodiment, the buses 104, 108, and 114 can be individual buses or part of the same bus. The chipset 110 can also include bus control and can handle transfers between the buses 104, 108, and 114.

According to another aspect, the chipset 110 can include an application specific chipset that connects to various buses, and integrates other system functions. For example, the chipset 110 can include using an Intel® Hub Architecture (HA) chipset that can also include two parts, a Graphics and GAP Memory Controller Hub (GMCH) and an I/O Controller Hub (ICH). For example, an Intel 820E, an 815E chipset, an Intel 975X chipset, an Intel G965 chipset, available from the Intel Corporation of Santa Clara, Calif., or any combination thereof, can be used as at least a portion of the chipset 110. The chipset 110 can also be packaged as an application specific integrated circuit (ASIC).

In one form, the chipset 110 can be coupled to a video graphics interface 122 using a third bus 124. In one form, the video graphics interface 122 can be a Peripheral Component Interconnect (PCI) Express interface operable to content to display within a video display unit 126. Other graphics interfaces may also be used. The video graphics interface 122 can output a video display output 128 to the video display unit 126. The video display unit 126 can include one or more types of video displays such as a flat panel display (FPD), cathode ray tube display (CRT) or other type of display device.

The information handling system 100 can also include an I/O interface 130 that can be connected via an I/O bus 120 to the chipset 110. The I/O interface 130 and I/O bus 120 can include industry standard buses or proprietary buses and respective interfaces or controllers. For example, the I/O bus 120 can also include a PCI bus or a high speed PCI-Express bus. In one embodiment, a PCI bus can be operated at approximately 66 MHz and a PCI-Express bus can be operated at more than one (1) speed (e.g. 2.5 GHz and 5 GHz). PCI buses and PCI-Express buses can comply with industry standards for connecting and communicating between various PCI-enabled hardware devices. Other buses can also be used in association with, or independent of, the I/O bus 120 including, but not limited to, industry standard buses or proprietary buses, such as Industry Standard Architecture (ISA), Small Computer Serial Interface (SCSI), Inter-Integrated Circuit (I²C), System Packet Interface (SPI), or Universal Serial buses (USBs).

In an alternate embodiment, the chipset 110 can be a chipset employing a Northbridge/Southbridge chipset configuration (not illustrated). For example, a Northbridge portion of the chipset 110 can communicate with the first physical processor 102 and can control interaction with the memory 112, the I/O bus 120 that can be operable as a PCI bus, and activities for the video graphics interface 122. The Northbridge portion can also communicate with the first physical processor 102 using first bus 104 and the second bus 108 coupled to the nth physical processor 106. The chipset 110 can also include a Southbridge portion (not illustrated) of the chipset 110 and can handle I/O functions of the chipset 110. The Southbridge portion can manage the basic forms of I/O such as Universal Serial Bus (USB), serial I/O, audio outputs, Integrated Drive Electronics (IDE), and ISA I/O for the information handling system 100.

The information handling system 100 can further include a disk controller 132 coupled to the I/O bus 120, and connecting one or more internal disk drives such as a hard disk drive (HDD) 134 and an optical disk drive (ODD) 136 such as a Read/Write Compact Disk (R/W CD), a Read/Write Digital Video Disk (R/W DVD), a Read/Write mini-Digital Video Disk (R/W mini-DVD), or other type of optical disk drive.

In one form, the information handling system 100 can include a DVB receiver module 138 coupled to an the I/O interface 130 and operable to be used with a DVB application 140 of the IHS 100 to output a DVB channel received within a multicast DVB broadcast signal or multicast DVB signal. In one form, a multicast DVB broadcast signal can include a DVB-H broadcast configured to be received by a handheld device operable to receive and output digital video broadcasts using a mobile handheld device including reduced-sized or mini-displays to display video and textual data. Multicast DVB-H broadcasts can be transmitted by wireless carriers using a time-slicing technique that can allow the DVB receiver module 138 to receive DVB data in short intervals, and can turn off or disable a portion of the DVB receiver module 138 during inactive periods. As such, a reduction in battery life of the IHS 100 can be realized. DVB-H broadcasts can also allow reception of video broadcast signals for various broadcast stations, programming, etc. DVB-H broadcasts can also include standardized broadcasts that comply with DVB-H specification DVB-H, published as European Telecommunication Standards Institute (ETSI) Standard EN 302 304 v1.1.1 in November 2004. Other types of broadcasts can also be used as desired, including, but not limited to, Integrated Services Digital Broadcast-Terrestrial (ISDB-T) in Japan, Terrestrial-Digital Multimedia Broadcasting (T-DMB) in Korea and DAB, incl. Digital Audio Broadcasting-Internet Protocol (DAB-IP) and Enhanced Packet mode Digital Audio Broadcasting (DAB) in Europe Middle East Asia (EMEA).

In one form, the DVB receiver 138 can be a removable card or expansion card that can be coupled to the I/O interface 130 as an add-on, or optional accessory or device for the IHS 100. The DVB receiver module 138 can be coupled to the I/O interface 130 and can receive power from the IHS 100 via the I/O interface 130. The DVB receiver module 138 can further include a DVB receiver module driver, software, or logic that can be employed by the IHS 100 and the DVB receiver module 138 to access and use of the DVB receiver module 138 using one or more applications of the IHS 100.

During use, the DVB receiver module 138 can periodically receive a DVB-H broadcast signals from a carrier and convert or decode the DVB broadcast signals to DVB broadcast data that can be formatted and communicated via the I/O interface 130 to the DVB application 140 of the IHS 100. In one form, the DVB broadcast data can be formatted into a communication bus dependent format. For example, the I/O interface 130 can include a PCI Express communication bus and the DVB-H broadcast data can be formatted into a signal that can be communicated via the PCI Express communication bus of the IHS 100. Other types of buses can also be employed as desired. The formatted data can be communicated to the DVB application 140, and the DVB application 140 can process the digital video broadcast information and decode the digital video broadcast data to output using the video display output 126. In this manner, DVB-H broadcast signals can be received by a DVB receiver module 138 coupled to the IHS 100 via an I/O interface and utilize resources of the IHS 100 to output the DVB-H signal data thereby enabling access of DVB-H broadcast data. A reduced amount of resources may be realized within the DVB receiver module 138 thereby allowing for a simplification of processing at the DVB receiver module 138 in some embodiments.

According to a further aspect, the IHS 100 can leverage compute and storage capabilities and access unique properties of DVB-H. For example, the IHS 100 can receive a multicast DVB-H signal and simultaneously decode, display for preview within the video display output 126, and record within the HDD 134 to later access and view multiple multi-cast IP data streams that can be encapsulated into a single transport stream within a DVB-H signal received by the IHS 100.

According to one aspect, while the IHS 100 can record one or more multicast data streams, and apply a timestamp to a data file storing the multicast data stream within the HDD 134. For example, the incoming multicast IP streams can be independently analyzed, and index frame pointers can be maintained within the HDD 134 or memory 112 noting the location of one or more frames within the multicast IP stream. In one form, a multicast data stream can be accessed using an “I-frame” within the IP stream. For example, an “I-frame” can include complete graphic images within the video stream. The IHS 100 can identify an “I-frame” within the video stream and store an index frame pointer to the most recent “I-frame” received. In this manner, an index frame pointer can be kept up-to-date on a rolling basis and can further be extracted from each stream within the multicast data stream. A user can then elect to change a channel, and the most recent I-frame of the chosen multicast stream can be selected and displayed. Subsequent frames can then be decoded upon selection of a channel. As such, access to channel data can be efficiently obtained by maintaining index points to “I-frames” within the data stream.

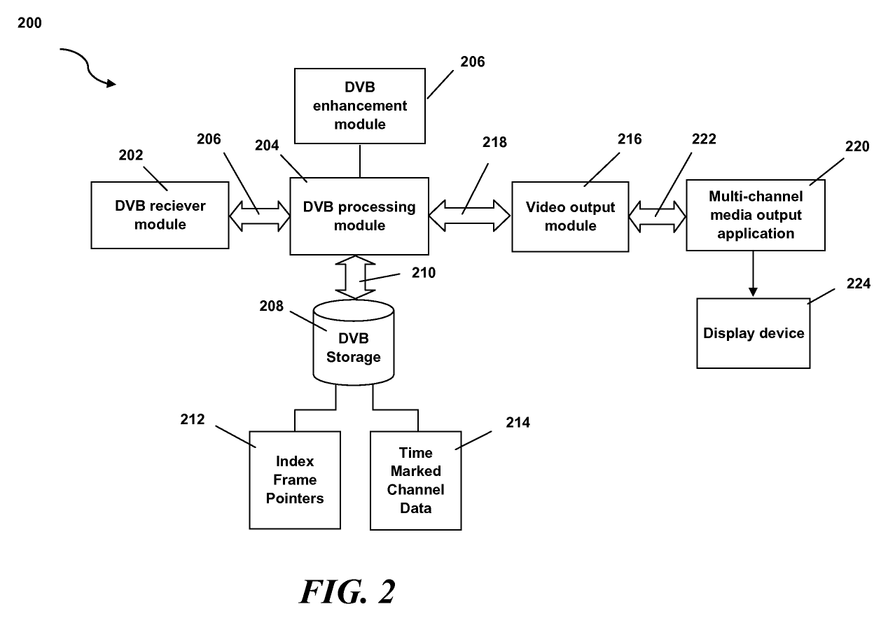

FIG. 2 illustrates a functional block diagram DVB processing system, illustrated generally at 200, according to one aspect of the disclosure. The DVB processing system 200 can be configured to be used be the information handling system 100 illustrated in FIG. 1, or various other types of information handling systems that can benefit from employing portions, or all of, the DVB processing system 200.

The DVB processing system 200 can include a DVB receiver module 202, a DVB processing module 204 coupled via a first interconnect bus 206. The DVB processing module 204 can also access a DVB enhancement module 206 and a DVB storage device 208 such as a HDD or other type of mass storage device. The DVB storage device 208 can be coupled to the DVB processing module 204 using a second interconnect bus 210. The DVB storage device 208 can be configured to store one or more index frame pointer 212 and a time marked channel data 214 that can include a plurality of DVB data streams. The index frame pointers 212 can include references to associated time marked channel data 214. The DVB processing system 200 can also include a video output module 216 coupled to the DVB processing module 218 using a third interconnect bus 218. The video output module 216 can be coupled to a multi-channel media output application 220 via a fourth interconnect bus 222 to output video to a display device 224. In one form, one or more of the interconnect buses 206, 210, 218, 222 can be realized as the same interconnect bus. According to another aspect, the DVB data can be formatted and output to a PCI-E bus of an IHS. For example, the DVB data can be formatted and inserted into an IP stream of the IHS and can include a multi-layer IP transmission signal. In other forms, the DVB data can be formatted and output using various other types of communication buses of an IHS as desired. Additionally, the DVB data can be combined with various other types of application data as desired.

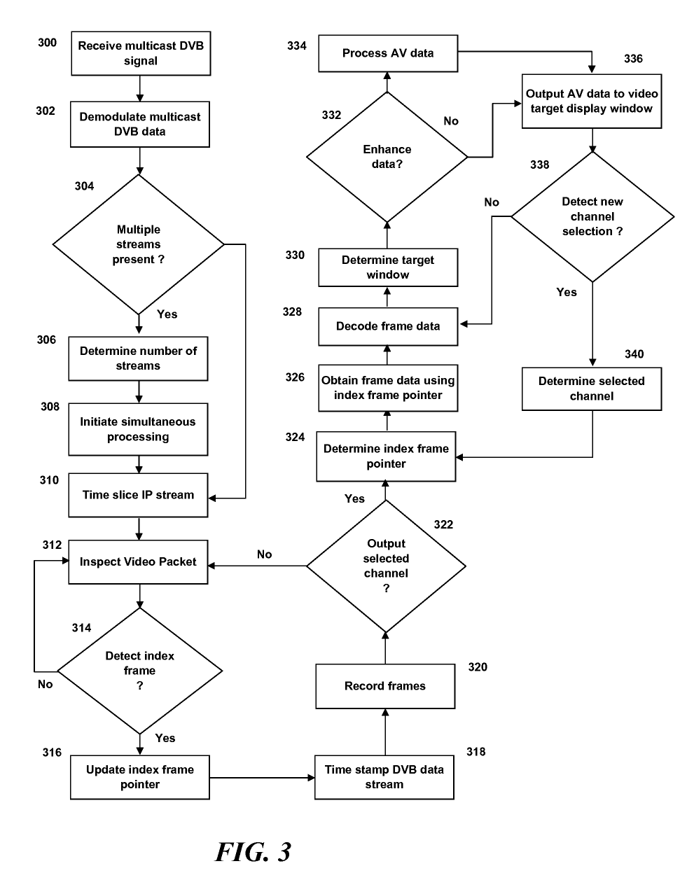

FIG. 3 illustrates a flow diagram of a method of accessing multiple digital video broadcasts streams from a multicast digital video broadcast signal according to one aspect of the disclosure. FIG. 3 can be employed in whole, or in part, by the information handling system 100 depicted in FIG. 1, the DVB processing system 200 described in FIG. 2, or any other type of system, controller, device, module, processor, or any combination thereof, operable to employ all, or portions of, the method of FIG. 3.

Additionally, the method can be embodied in various types of encoded logic including software, firmware, hardware, or other forms of digital storage mediums, computer readable mediums, or logic, or any combination thereof, operable to provide all, or portions, of the method of FIG. 3.

The method begins generally at block 300 as a multicast DVB signal can be received by a DVB receiver module coupled to an information handling system. In one form, the multicast DVB signal can be received for a specific signal carrier or multiple carriers. Upon receiving the multicast DVB signal, the method can proceed to block 302 and the multicast DVB signal can be demodulated to extract one or more DVB data streams from the multicast DVB signal. For example, the multicast DVB signal can include a multiple channel broadcast signal including DVB channel data streams within the multicast DVB signal. As such, the multiple channel broadcast data streams can be extracting from the DVB signal. The method can then proceed to decision block 304, and determines if multiple streams are present. If multiple streams are not present, the method can proceed to block 310 as described below. If at decision block 304, there are more than one DVB streams, the method proceeds to block 306 and determines the number of streams. The method can then proceed to block 308 and a simultaneous processing of each data stream can be initiated. In one form, any number of data streams can be simultaneously processed. For example, if four (4) data streams are present, one, more than one, or all of the data streams can be decapsulated using a parallel process. The method can then proceed to block 310 and each stream can be time sliced. For example, each data stream can include a series of packets including multiple frames. The packets can be separated over the specific interval. Each video packet within the sliced interval can be inspected to determine if an index frame is detected. For example, an index frame can include a reference to identify a subsequent series or group of video frames. In one form, the index frame can include an “I-frame” or other marker that can be detected.

If an index frame is not detected, the method can proceed to decision block 314 and continues to inspect video packets within the DVB data stream. If at decision block 314, an index frame is detected, the method can proceed to block 316 and an index frame pointer can be updated to include a reference to the data packet or frame including the index frame pointer. In one form, multiple pointers for multiple DVB data streams can be maintained within a memory and updated as desired when an index frame pointer may be detected.

Upon updating the index frame pointer, the method can proceed to block 318 and the DVB data stream can be time stamped to identify a starting point within the DVB data stream and proceeds to block 320 and records video frames of the DVB data stream to a memory such as digital storage device, hard disk drive, one or more flash memory, or various other types of memory that can record video frames. In one form, the video frames and the updated index pointer reference can be stored within the same storage device, or within separate storage device. Upon recording the video frames, the method can proceed to decision block 322 and determines if the video frames should be output to a display.

If at the decision block 322 a DVB channel data and associated video frames are not to be output, the method can proceed to block 312 and proceeds as described above. If at decision block 322, the DVB channel data is to be output, the method can proceed to block 324 and determines an index frame pointer value of the DVB data stream, and to step 326 where and obtains the video frame data of the DVB data stream using the index frame pointer. For example, an H.264 or WMV9 (Microsoft's Windows Media Version 9) decoder, or any combination thereof, to decode the video frame data. The method can then proceed to block 328 and decodes the DVB frame data. The DVB frame data can be decoded using a frame data video decoder operable to extract the video content and any additional content or information that may be included within the DVB data stream. For example, electronic service guide (ESG) data such as program names, titles, broadcast channels, channel identifier data, sponsorship data, broadcast data, or various other types of information can be included within the DVB data stream.

In one form, the DVB frame data also includes AV data having a specific AV format, such as an MPEG, or other format. As such, the DVB frame data can be decoded and the method can proceed to block 330 and determines a target window to display the video data, additional data, or any combination thereof. In one form, the target window can include a window having a window size configured to display the video content based on a format of the DVB data stream.

For example, the DVB data stream can include a DVB-H data stream configured to be displayed at a window size or video resolution of 320×240 pixels or less (e.g. 192×144 pixels) up to 15-30 frames per second with a bit rate of 200-384 Kbps. Other configurations can also be used as desired. In one form, the target or main window can be automatically scaled to a fraction of the available display resolution of the display operable to output the DVB video content. In other forms, the target or main window can be scaled to the maximum resolution available to the display. For example, the target or main window having an available display the DVB video content can be displayed without having to modify the video data. However, in other embodiments, the target window can include a window size greater than what may be typical to display DVB video content. As such, if the target window is greater, the method can proceed to block 334 and the video data can be processed to enhance the DVB video content to be displayed in the target window.

According one aspect, one or more frames can be modified to increase an overall resolution, display, forward error correction, or various other processing that can be used to enhance the overall output quality of the DVB video data. For example, a spatial interpolation process can be used to increase the apparent video resolution of the display without introducing video (e.g. blockiness) within the video data. In another aspect, a temporal interpolation process can be used to reduce motion judder that may be caused from displaying DVB video content using a higher frame rate display or refresh rate (e.g. 60 Hz, 120 Hz) than the DVB video content that may have been provided at a lower frame rate (e.g. 25 Hz, 30 Hz). The temporal interpolation process can include a motion compensated frame-rate conversion process to correct artifacts that can be caused due to variances in frame rates in DVB video data.

Upon enhancing the DVB data, the method can proceed to block 336 and the DVB video data, or DVB channel data, can be output to the target window of a display of an information handling system. For example, the graphical user interface of FIG. 6 as described below can be used to display the DVB channel data. Upon displaying the DVB channel data, the method can proceed to decision block 338 and detects if a new DVB channel has been selected. For example, a user can select a different channel provided within the multicast DVB signal to display, record, output, preview, or any combination thereof. As such, if a DVB channel change is not detected, the method can proceed to block 328 and repeats. If at decision block 338, a new channel selection is detected, the method can proceed to block 340 and determines the DVB channel selected by the user. In one form, a preview or mosaic of selectable DVB channel windows can be output to a user and selected by a user to be displayed. In other forms, a channel selector, link, or any combination or selection logic can be employed to receive a selection. Upon determining a selected channel, the method can then proceed to block 324 and determines an index frame pointer reference to the newly selected channel, and repeats as described above.

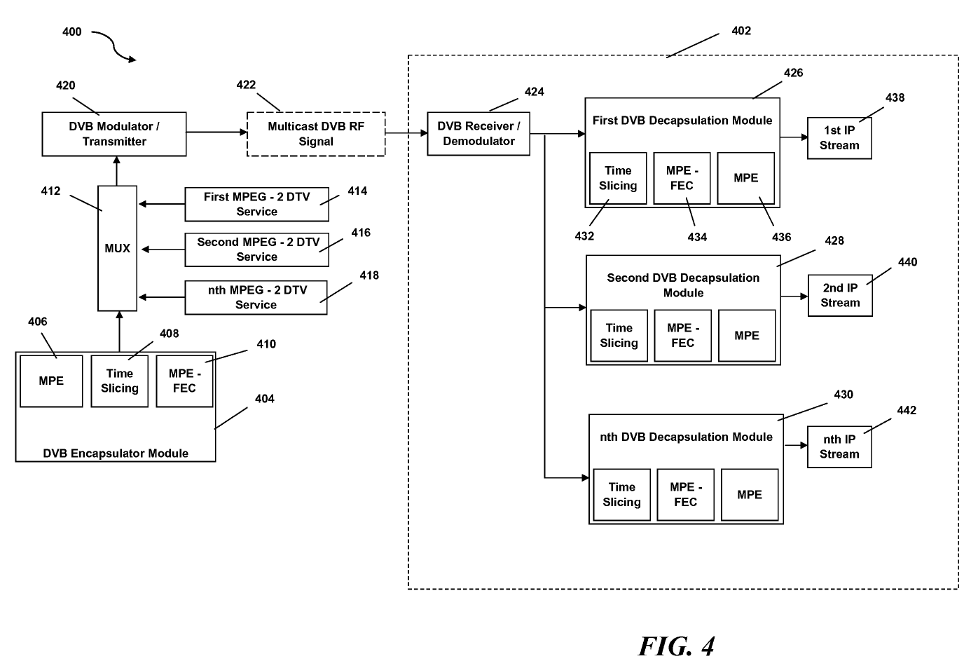

FIG. 4 illustrates a functional block diagram of a DVB network, illustrated generally at 400, that can be coupled to a DVB processing system, illustrated generally at 402. The DVB network 400 can employ a DVB encapsulation module 404 including an (Multi-Program Encapsulation) MPE module 406, a time slicing module 408, and an MPE-Foreword Error Correction (FEC) module 410 to recover lost bits or data. The DVB encapsulation module 404 can be coupled to a DVB multiplexer (MUX) 412 operable to receive multiple inputs to generate a multicast DVB signal. For example, the MUX 412 can receive an input from a first MPEG-2 DTV service 414, a second MPEG-2 DTV service 416, an n^{th} MPEG-2 service, or any combination thereof. The MUX 412 can be used in combination with the DVB encapsulation module 404 to encapsulate various types of content, video, graphics, etc. prior to transmitting a multicast DVB signal. The MUX 412 can output a multicast signal to a DVB modulator/transmitter 420 operable to transmit the multicast DVB signal using an RF signal and carrier. For example the DVB modulator/transmitter 420 can broadcast a multicast DVB RF signal 422 operable to be received by one or more RF receivers configured to receive a multicast DVB RF transmission. For example the multicast DVB RF signal can be a DVB-H compliant or other standards DVB RF signal.

According to one aspect, the DVB processing system 402 can include a DVB receiver/demodulator 424 operable to receive the multicast DVB RF signal 422. In one form, the DVB receiver/demodulator 424 can demultiplex the multicast DVB RF signal 422 to access multiple DVB data streams within the DVB multicast DVB RF signal 422. As such, the DVB processing system 402 can parallel process each of the DVB data streams using a decapsulation module, software application, or process. For example, the DVB processing system 402 can employ a first DVB decapsulation module 426, a second DVB decapsulation module 428, an nth DVB decapsulation module 430, or any combination thereof to decapsulate one or more DVB data streams.

In one form, the IHS 100 illustrated in FIG. 1 can employ parallel processing of the DVB data streams. Each DVB decapsulation module can employ additional modules or processes. For example, a time slicing module 432 can be used to determine a time interval of a DVB data stream, an MPE-CPE module 434, and MPE module 436, can be used to access and correct video frames or video data within each DVB data stream. Upon decapsulating each DVB data stream, the first DVB decapsulation module 426 can output a first IP stream including a first DVB channel data operable to be used by the DVB processing system 402. Additionally, the second DVB decapsulation module 428 can output a second IP stream including a second DVB channel data, and the nth DVB decapsulation module 430 can output an n^{th} IP stream 442 including an n^{th} DVB channel data. Each IP stream can be output to a communication bus of an information handling system to be processed, enhanced, modified, output, or any combination thereof.

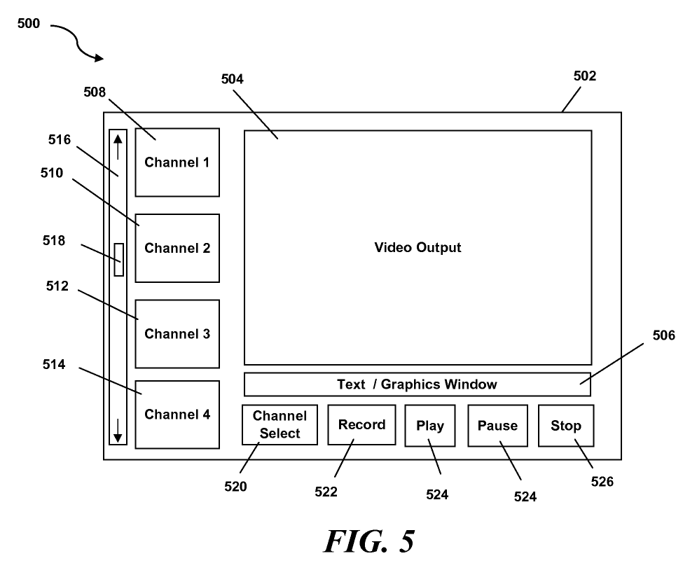

FIG. 5 illustrates a graphical user interface, illustrated generally as GUI 500, operable to display simultaneous DVB channels according to one aspect of the disclosure. The GUI 500 can output a multi-channel media output 502 including a first window 504, a textual or graphics window 506, a second window 508, a third window 510, and a fourth window 514. Additional windows can also be output and accessed using a scroll bar 516 and controller 518. According to one aspect, the first window 504 can be used as a primary window and can be sized larger than the second through fourth windows 508, 510, 512, 516. Additionally, one or more of the second through fourth windows 508, 510, 512, 516 can be configured to be selectable enabling a user to display video or video frames displayed within the second through fourth windows 508, 510, 512, 516 to the first window 504. For example, a user may select a first channel being displayed within the second window 508 and the video data for the first channel can be output to the first window 504. The GUI 500 can also include a channel selector 520, a record element 522, a play element 524, a pause element 524, and a stop element 526. Each element can include an underlying software logic or function that can be used to play or record a DVB channel or program. Additional functions or features may also be employed.

During use, a user can access the GUI 500 via an IHS configured to output a multicast DVB channel data. For example, the IHS 100 of FIG. 1 can employ the GUI 500 to output multiple DVB channels to a user. In one form, a first DVB channel can be displayed within the first window 504 and can include enhanced DVB content that can be processed to be output within the first window 504. Additionally, the GUI 500 can include the second window 508 that can include a window size configured to comply with a DVB standard. As such, the DVB channel data output within the second window 508 may not require enhancing to be output. According to a further aspect, the GUI 500 can simultaneously output multiple DVB channels that can be accessed simultaneously from a multicast DVB RF signal. In this manner, a user can be provided a visual indication of multiple DVB channels that are broadcast within the DVB signal to allow a user to select, record, view, etc. as desired.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a digital video broadcast (DVB) receiver operable to receive a multicast DVB signal;
a processor operable to initiate processing of the multicast DVB signal;
a demodulator operably coupled to the processor, the demodulator operable to detect a first DVB data stream within the multicast DVB signal;
a decapsulation module accessible by the DVB processing module and operable to detect a first index frame within the first DVB data stream;
a storage device operable to store a first index frame pointer reference operable to be updated in response to detecting the first index frame to identify the first index frame;
the storage device further operable to store the first DVB data stream relative to the first index frame; and
a display operable to display a first DVB channel data of the first DVB data stream, and a subsequent related first DVB channel data within a first window.

2. The information handling system of claim 1, further comprising a DVB enhancement module operable to process the first DVB data stream to format the first DVB data stream into an enhanced DVB channel data formatted to be output within the first window.

3. The information handling system of claim 1, wherein:
the processor is further operable to initiate detection of a plurality of index frames within the multicast DVB signal;
the processor is further operable to initiate an updating of a plurality of index frame pointer references in response to the detection of the plural index frames; and
the storage device is further operable to store an updated plurality of index frame pointer references and an associated DVB data stream of each index frame.

4. The information handling system of claim 3, wherein:
the processor is further operable to initiate a detection of the index frames in parallel; and
the processor module is further operable to initiate a simultaneous storage of a multiple of DVB data streams within the storage device in response to detecting the plurality of index frames.

5. The information handling system of claim 1, further comprising:
a first window including a first display size; and
a plurality of second windows operable to be displayed with the first window, the plurality of second windows each having a second display size smaller than the first display size.

6. The information handling system of claim 5, further comprising:
a video data enhancement module operable to process the first DVB channel data to output a first enhanced channel data within the first window; and
a video output module operable to output a plurality of video data channels of the multicast DVB data streams to the plurality of second windows, the video output module is further operable to output the first enhanced channel data within the first window.

7. The information handling system of claim 6, further comprising:
a plurality of selectable elements associated with the plurality of second windows, the plurality of selectable elements operable to enable selection of each of the plurality of second windows to output at least one video channel data within the first window; and
an updateable text output window located proximal to the first window and operable to display information related to the enhanced channel data displayed within the first window.

8. The information handling system of claim 7, wherein processor is further operable to:
detect a selection of at least a first selectable element;
determine a related index frame pointer reference in response to the selection of the first selectable element; and
initiate access to a related digital DVB data stream stored within the storage device to output to the first window.

9. The information handling system of claim 1, wherein the processor is further operable to:
detect a request to record a second video channel data; and
simultaneously initiate a recording of the second video channel data and while maintaining an outputting of the first video channel data within the first window.

10. A method of processing a digital video broadcast signal, the method comprising:
receiving a multicast digital video broadcast (DVB) signal;
demodulating the multicast DVB signal to access a plurality of DVB data streams;
initiating a processing the plurality of DVB data streams using a first DVB decapsulation module to detect a first DVB data stream and a second DVB data stream;
detecting a first index frame within the first DVB data stream;
detecting a second index frame within the second DVB data stream;
storing a second index frame pointer reference identifying the second index frame; and
storing the second DVB data stream relative to the second index frame within a storage device.

11. The method of claim 10, further comprising:
initiating an outputting of the first DVB data stream to a first display window; and
initiating an outputting of the second DVB data stream to a second display window.

12. The method of claim 10, further comprising:
processing the first DVD data stream and the second DVB data stream in parallel; and
simultaneously storing the first DVB data stream and the second DVB data stream within the storage device.

13. The method of claim 10, further comprising:
receiving a request to access the second DVB data stream;
determining the second index frame pointer reference of the second DVB data stream; and
outputting the second DVB data stream.

14. The method of claim 13, further comprising:
processing the first DVB data stream to output an enhanced first DVB data channel formatted to be display within a first display window including a first display size;
outputting the enhanced first DVB data channel to the first display window; and
outputting a second DVB data channel of the second DVB data stream to a second display window, the second display window including a second display size smaller than the first display size.

15. The method of claim 10, further comprising:
recording the second DVB data stream within the storage device;
outputting a first DVB channel data of the first DVB data stream to a first window;
detecting a selection of the second channel;
outputting a second DVB channel data of the second DVB data stream to a second window; and
enabling an outputting of the first DVB channel data to the second window.

16. The method of claim 10, wherein the recording further includes:
receiving a request to record the first DVB channel stream;
determining a time interval to record the first DVB channel stream;
storing the first DVB channel stream within the storage device; and
enabling access to the stored first DVB channel stream at a later time.

17. An information handling system comprising:
a wireless digital video broadcast (DVB) receiver operable to receive a multicast DVB signal including a plurality of DVB data streams;
a demultiplexer operable to separate the plurality of DVB data streams;
a storage device operable to store time sliced video frames of the plurality of DVB data streams;
a processor operable to initiate a decapsulation and detection of a plurality of index frames within each of the plurality of DVB data streams;
a plurality of index frame pointer references updated in response to detecting the plurality of index frames; and
a graphical user interface including:
a scalable display window operable to display a first enhanced DVB channel data, the first display window including a first window size; and
a second display window operable to display a second DVB channel data, the second display window including a second window size smaller than the first window size.

18. The information handling system of claim 17, further comprising:
a first selectable region operably associated with the second display window; and
the processor responsive to a user selection of the first selectable region and operable to initiate an outputting of the second DVB channel data to the first display window.

19. The information handling system of claim 18, further comprising:
a video enhancement module operable to format the second DVB channel data prior to outputting to the first display window; and
the processor further operable to update the first index pointer reference upon detecting a subsequent index frame within the first DVB data stream.

20. The information handling system of claim 19, further comprising the processor operable to initiate a recording of the first DVB data stream in response to updating the first index pointer reference.
